(19) United States
(12) Patent Application Publication
(10) Pub. No.: US 2006/0280586 A1
(43) Pub. Date: Dec. 14, 2006

(54) Substrate conveyance apparatus

(75) Inventor: Tze-Wei Chou, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/443,541

(22) Filed: May 30, 2006

(30) Foreign Application Priority Data
May 27, 2005 (TW) 94117391

(51) Int. Cl. B66C 23/00

(52) U.S. Cl. 414/744.6

(57) ABSTRACT

The present invention relates to a substrate conveyance apparatus (200). The apparatus includes a main frame (230), a substrate support device (240) and a base plate (210). The substrate support device includes robot blades (141a, 141b) and a holding chuck (145). The holding chuck is movably connected with main frame so as to hold the robot blades. The robot blades are comprised of two pair of plate-shaped members, and the base plate is used to support the main frame. The distance between one pair of plate-shaped members is different from that of the other pair of plate-shaped members. The substrate conveyance apparatus is used to load/unload the substrates with different sizes.

### BACKGROUND OF THE INVENTION

1. Field of the Invention

The present invention relates to a substrate conveyance apparatus for conveying semiconductor wafers or substrates of liquid crystal display panels.

2. General Background

In general, circuits or electrodes are patterned on a semiconductor device or the like by a lithography process. A series of steps are performed sequentially in the lithography process. In particular, a substrate is rinsed, cleaned, and dried. A photoresist layer is then formed on the substrate, and the photoresist layer undergoes an exposure process, a development process, and the like. During the above-mentioned processes, the substrate is unloaded from a cartridge of a cassette and is conveyed to respective one or more processing units (or stations). For example, the substrate undergoes a rinse process in one of the processing units, and then the substrate is loaded back into the same cassette after the processing of the substrate in the processing unit is finished. Typically, the substrate is unloaded from and loaded into the cassette by an arm-like robotic device.

FIG. 4 is a schematic, isometric view of a conventional substrate conveyance device 10 in a typical application environment. The substrate conveyance device 10 is used to unload one of substrates 7 from a cassette 4. The cassette 4 is supported on a cassette pod 2. The cassette pod 2 may, for example, be dedicated to a single particular processing unit (or station) (not shown), and be located at one end of the processing unit. Typically, the substrate conveyance device 10 unloads two substrates 7, and after processing of the substrates 7 is completed, the substrate conveyance device 10 may load the substrates 7 onto another cassette 4 (not shown) located at an opposite end of the processing unit. Thereafter, the substrates 7 are ready to be unloaded from the other cassette 4 for processing at a next processing unit (not shown).

The substrate conveyance device 10 includes a base plate 11, a drive device 12, a main frame 13, and a substrate support device 14. The substrate support device 14 is connected with the main frame 13 by a pair of connection pieces (not labeled). The main frame 13 having the substrate support device 14 thereon is fixed on the base plate 11. The drive device 12 is also fixed on the base plate 11. The base plate 11 is slidably supported on a pair of guide rails (not labeled).

The main frame 13 includes a support base 132, a lifting rod 134, a pair of rotatable rods 136, and a pair of rotatable rods 137. The support base 132 is fixed on the base plate 11, and the lifting rod 134 can be lifted, lowered and/or rotated with respect to the support base 132. The pair of rotatable rods 136 are connected with the lifting rod 134 by a supporting plate (not labeled), and can rotate with respect to the support base 132. Further, each rotatable rod 137 can rotate with respect to its corresponding connecting rotatable rod 136.

The substrate support device 14 includes a pair of upper robot blades 141a and 141b, a pair of lower robot blades 142a and 142b, and a holding chuck 145. The holding chuck 145 is movably connected with the rotatable rods 137 by the connection pieces (not labeled) respectively. The holding chuck 145 is used to fixedly hold the pair of upper robot blades 141a and 141b and the pair of lower robot blades 142a and 142b. Each of the upper and lower robot blades 141a, 141b, 142a, 142b has the same elongated plate-shaped configuration. The upper and lower robot blades 141a, 141b, 142a, 142b are parallel to each other, and same ends of the upper and lower robot blades 141a, 141b, 142a, 142b are fixed to the holding chuck 145. A distance between the pair of upper robot blades 141a and 141b is equal to that between the pair of lower robot blades 142a and 142b.

In typical operation of the substrate conveyance device 10, the upper and lower robot blades 141a, 141b, 142a, 142b are cooperatively rotated, lifted, and lowered, so that two of the substrates 7 are unloaded from the cassette 4, processed at the processing unit, and finally loaded onto another one of the cassettes 4 (not shown). Conventionally, the pair of upper robot blades 141a, 141b are spaced apart a distance approximately equal to a width of each of the substrates 7, and the pair of lower robot blades 142a, 142b are spaced apart the same distance.

However, the distance between the pair of upper robot blades 141a, 141b is fixed, and the distance between the pair of lower robot blades 142a, 142b is also fixed. Therefore if the two substrates 7 being conveyed have different sizes, the difference cannot be substantial and the substrates 7 need to be similarly sized. Thus, if the two substrates 7 are substantially different in size, a second substrate conveyance apparatus 10 may be required. That is, one substrate conveyance apparatus 10 is needed for a first-sized one of the substrates 7, and another substrate conveyance apparatus 10 is needed for a second-sized one of the substrates 7. The need for an additional substrate conveyance apparatus 10 increases the cost of processing the substrates 7.

### SUMMARY

A substrate conveyance apparatus for transporting the substrates with different sizes is provided.

The substrate conveyance apparatus includes a main frame, a substrate support device and a base plate. The substrate support device includes robot blades and a holding chuck. The holding chuck is movably connected with main frame so as to hold the robot blades. The robot blades are comprised of two pair of plate-shaped members, and the base plate is used to support the main frame. The distance between one pair of plate-shaped members is different from that of the other pair of plate-shaped members.

Compared with the prior art, the present substrate conveyance apparatus provides the robot blades having two pair of plate-shaped members. The distance between one pair of plate-shaped members is different from that of the other pair of plate-shaped members. That is, one pair of the plate-shaped members is used to support substrates with one size, and the other pair of plate-shaped members is used to support substrates with the other size. Thus, the substrate conveyance apparatus of the present invention is used to load/unload the substrates with different sizes so that the number of the substrate conveyance apparatus is minimized and cost of liquid crystal display is reduced.

A detailed description of embodiments is given hereinbelow with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a perspective view of the substrate conveyance apparatus according to an exemplary embodiment of the present invention;

FIG. 2 is a perspective view of the substrate conveyance apparatus of FIG. 1, illustrating how the substrate conveyance apparatus supports a substrate with a smaller size;

FIG. 3 is a perspective view of the substrate conveyance apparatus of FIG. 1, illustrating how the substrate conveyance apparatus supports a substrate with a larger size; and

FIG. 4 is a perspective view of a conventional substrate conveyance apparatus.

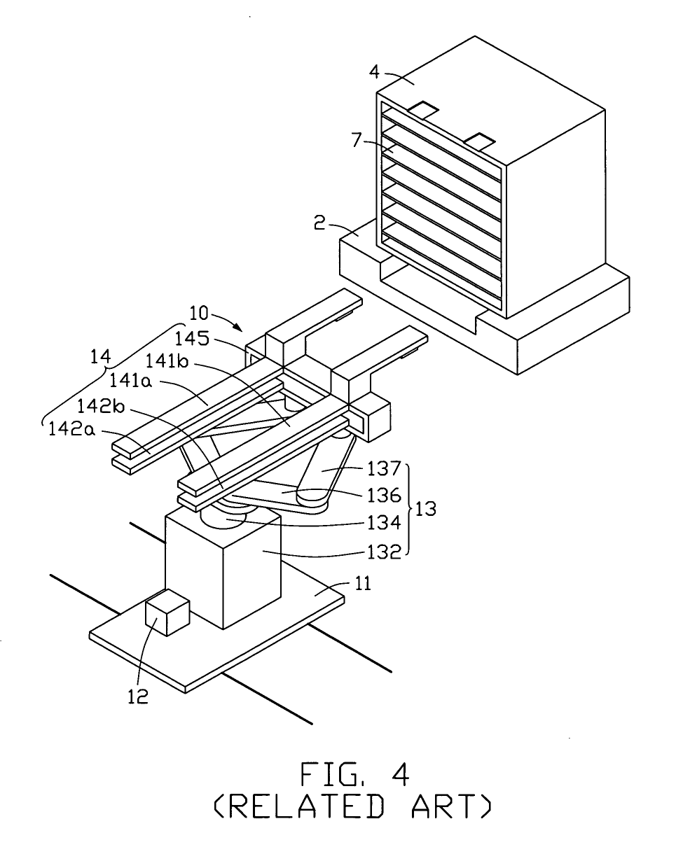

### DETAILED DESCRIPTION

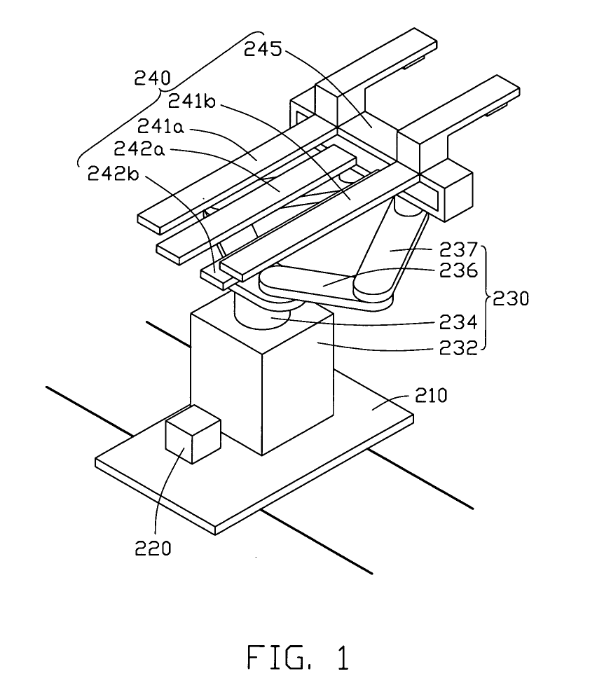

FIG. 1 illustrates a substrate conveyance apparatus 200 of an exemplary embodiment of the present invention. The substrate conveyance apparatus 200 includes a base plate 210, a drive device 220, a main frame 230, and a substrate support device 240. The substrate support device 240 is connected with the main frame 230. The main frame 230 having the substrate support device 240 thereon is fixed on the base plate 210. The drive device 220 is also fixed on the base plate 210, and is used to drive the substrate conveyance apparatus 200 including the base plate 210. The base plate 210 is slidably supported on a pair of guide rails (not labeled). Thus the substrate conveyance apparatus 200 can be used to transport substrates between processing stations (not shown) in a manufacturing facility.

The main frame 230 includes a support stage 232, a lifting rod 234, a pair of rotatable rods 236, and a pair of rotatable rods 237. The support stage 232 is fixed on the base plate 210, and the lifting rod 234 can be lifted, lowered and/or rotated with respect to the support stage 232. The pair of rotatable rods 236 are connected with the lifting rod 234 by a supporting plate (not labeled), and can rotate with respect to the support stage 232. Further, each rotatable rod 237 can rotate with respect to its corresponding connecting rotatable rod 236.

The substrate support device 240 includes a first pair of robot blades 241a and 241b, a second pair of robot blades 242a and 242b, and a holding chuck 245. The holding chuck 245 is movably connected with the rotatable rods 237. The holding chuck 245 is used to fixedly hold the first pair of robot blades 241a and 241b and the second pair of robot blades 242a and 242b. Each of the robot blades 241a, 241b, 242a, 242b has the same elongated plate-shaped configuration. The robot blades 241a, 241b, 242a, 242b are parallel to each other, and same ends of the robot blades 241a, 241b, 242a, 242b are fixed to the holding chuck 245.

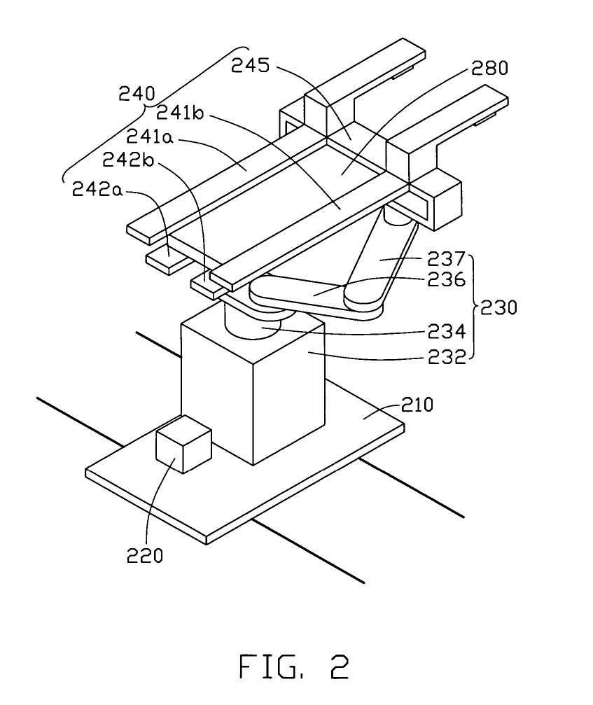

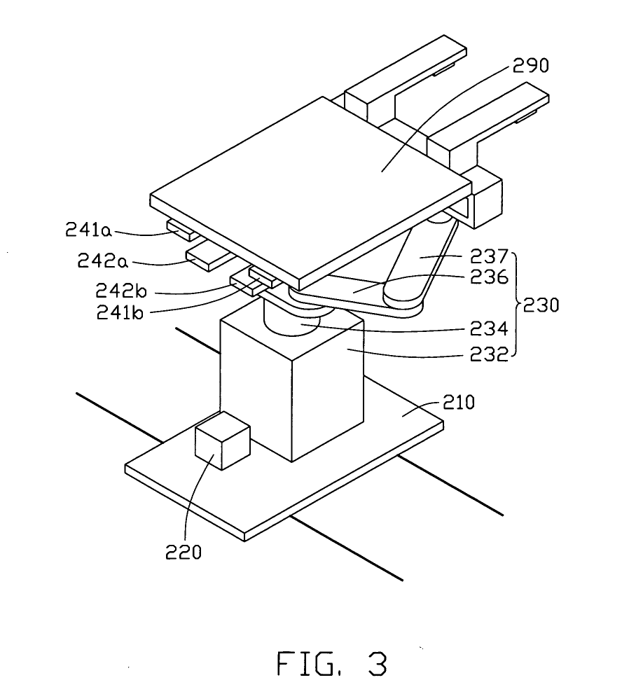

A distance between the first pair of robot blades 241a and 241b is larger than between the second pair of robot blades 242a and 242b. As shown in FIG. 2, the second pair of robot blades 242a and 242b is used to support a substrate 280 with a smaller size. As shown in FIG. 3, the first pair of robot blades 241a and 241b is used to support a substrate 290 with a larger size.

Alternately, the second pair of robot blades 242a and 242b can be adapted to support the substrate 290 with a larger size, and the first pair of robot blades 241a and 241b can be adapted to support the substrate 280 with a smaller size.

In addition, the first pair of robot blades 241a and 241b can be used to support a substrate (not shown) with a suitable size that is different from the substrate 290 with a larger size. Similarly, the second pair of robot blades 242a and 242b can be used to support a substrate (not shown) with a suitable size that is different from the substrate 280 with a smaller size.

Unlike in the prior art, the present invention provides the substrate conveyance apparatus 200 having the first pair of robot blades 241a and 241b and the second pair of robot blades 242a and 242b. The distance between the first pair of robot blades 241a and 241b is different than that between the second pair of robot blades 242a and 242b. Therefore the first pair of robot blades 241a and 241b can be used to support a substrate with one size, while simultaneously the second pair of robot blades 242a and 242 can be used to support a substrate with another size. That is, the substrate conveyance apparatus 200 is able to support and transport substrates with substantially different sizes. Therefore in certain applications, there is no need for a second substrate conveyance apparatus in order to effect transportation of such substrates, and the cost of processing the substrates can be minimized. Thus in one kind of application, the cost of manufacturing liquid crystal displays is lowered.

While principles of the invention have been described by way of example and in terms of one or more preferred embodiments, it is to be understood that the invention is not limited thereto. To the contrary, the description is intended to cover various modifications and similar arrangements (as would be apparent to those skilled in the art). Therefore, the scope of the appended claims should be accorded the broadest interpretation so as to encompass all such modifications and similar arrangements.

We claim:

1. A substrate conveyance apparatus, comprising:
a base plate;
a main frame, positioned at the base plate; and
a substrate support device, including robot blades and a holding chuck, and the holding chuck movably connected with main frame so as to hold the robot blades, and the robot blades are comprised of two pair of plate-shaped members, wherein a distance between one pair of plate-shaped members is different from that of the other pair of plate-shaped members.

2. The substrate conveyance apparatus as claimed in claim 1, wherein each of the two pair of plate-shaped members includes a pair of slender members and has identical length.

3. The substrate conveyance apparatus as claimed in claim 2, wherein the distance between one pair of plate-shaped members is larger than that of the other pair of plate-shaped members.

4. The substrate conveyance apparatus as claimed in claim 1, further comprising a drive device positioned at the base plate.

5. The substrate conveyance apparatus as claimed in claim 1, wherein the main frame includes a support base, a lifting rod and a pair of rotatable rods, and the support base is positioned at the base plate so that the lifting rod is lifted, lowered or rotated with respect to the support base and is connected with the pair of rotatable rods.

6. The substrate conveyance apparatus as claimed in claim 5, wherein the pair of rotatable rods are rotatably connected each other.

7. A substrate conveyance apparatus, comprising:
a base plate;
a main frame, positioned at the base plate; and
a substrate support device, including robot blades and a holding chuck, and the holding chuck movably connected with main frame so as to hold the robot blades, and the robot blades comprising upper and lower pairs of plate-shaped members, wherein the upper pair defines a first transverse dimension which is larger than a second transverse dimension defined by the lower pair.

8. A substrate conveyance apparatus, comprising:
a base plate;
a main frame, positioned at the base plate; and
a substrate support device, including robot blades and a holding chuck, and the holding chuck movably connected with main frame so as to hold the robot blades, and the robot blades comprising upper and lower pairs of plate-shaped members, wherein the upper pair defines a first transverse dimension which is different from a second transverse dimension defined by the lower pair.
